(19) United States
(12) Patent Application Publication
(10) Pub. No.: US 2017/0089107 A1
(43) Pub. Date: Mar. 30, 2017

(54) TRI-LINKS LATCH

(71) Applicant: Alcoa Inc., Pittsburgh, PA (US)

(72) Inventor: Thai Do, Laguna Niguel, CA (US)

(73) Assignee: Alcoa Inc., Pittsburgh, PA (US)

(21) Appl. No.: 15/278,159

(22) Filed: Sep. 28, 2016

Related U.S. Application Data
(60) Provisional application No. 62/234,145, filed on Sep. 29, 2015.

(51) Int. Cl. E05C 19/14

(52) U.S. Cl. CPC E05C 19/14

(57) ABSTRACT

A latch having body with a hook, a handle attached pivotally to the body, and a series of links that facilitate opening and closing the handle. The links include a pair of front links, a pair of back links, and a middle link. The middle link connects the front links and the back links at one end of the middle link and with slots in the front link. The other end of the middle link pivots with the handle via a rivet. The middle link acts as an extended arm to drive the front links and back links for opening and closing the latch. A handle spring provides a means to pop-open the handle. A pair of link covers retains the front links and the back links on the body.

### CROSS-REFERENCE TO RELATED APPLICATION

This application is a §111(a) application that relates to and claims the benefit of commonly-owned, co-pending U.S. Provisional Patent Application Ser. No. 62/234,145, filed Sep. 29, 2015, entitled “TRI-LINKS HOOK LATCH,” the entirety of which is incorporated herein by reference.

### FIELD OF THE INVENTION

The present invention relates to a latch and, more particularly, to a latch having a series of links utilized for opening and closing the latch.

### SUMMARY OF THE INVENTION

In an embodiment, a latch, comprising a body having a first end, a second end opposite the first end, a hook located at the second end, and a pair of side portions located intermediate the first and second ends, the body being moveable axially and rotatably from a first position to second position; a handle attached pivotally to the first end of the body, the handle being moveable from a closed position, in which a portion of the handle is attached releasably to the body, and an open position, in which the portion of the handle is detached from the body; a pair of first links, each of which is attached rotatably to a corresponding one of the side portions of the body proximate to the first end of the body, each of the first links being moveable from a first position to a second position; a pair of second links, each of which is attached rotatably to a corresponding one of the side portions of the body proximate to the first end of the body and overlapping a corresponding one of the first links, each of the second links being moveable from a first position to a second position; and a third link having a pair of elongated link members, a first end of each of the link members being attached to a corresponding one of the second links and an opposite, second end of each of the link members being attached to the handle, when the handle is pivoted from its closed position to its open position, the handle pulls the third link which, in turn, rotates each of the second links from its first position to its second position and each of the first links from its first position to its second position, and when each of the second links is moved to its second position, the body moves from its first position to its second position.

In an embodiment, each of the side portions of the body includes an elongated slot, and each of the second links includes a first end and a second end opposite the first end of the second link, each of the first ends of the second links being attached to the corresponding one of the side portions of the body by a mounting bushing positioned moveably within a corresponding one of the slots of the side portions of the body. In an embodiment, each of the second ends of the second links includes an elongated slot having a first end and a second end opposite the first end of the slot of the second link, each of the second ends of the link members of the third link being attached to a corresponding one of the first ends of the second links by a guide pin positioned moveably within a corresponding one of the slots of the second links.

In an embodiment, when the handle is moved from its closed position to its open position, the first links rotate in a first direction and the second links rotate in a second direction opposite the first direction, each of the guide pins moves within the corresponding slot of the second links from the first end of the slot of the second link to the second end of the slot of the second link, and each of the bushings move within the corresponding slot of the side portions of the body from the corresponding second end of the slot to the corresponding first end of the slot. In an embodiment, a back link rivet extends between and interconnecting the pair of first links to one another.

In an embodiment, each of a pair of link covers connects a corresponding one of the second links with a corresponding one of the first links by a pair of hook rivets. In an embodiment, the latch includes a spring positioned on one of the hook rivets and engaging the back link rivet. In an embodiment, the handle includes a pair of side members, and the body includes a first support member extending outwardly from the first end thereof, the first support member including a pair of legs, each of which is attached to a corresponding one of the side members of the handle by a handle rivet. In an embodiment, the latch includes a handle spring located on the handle rivet.

In an embodiment, the body includes a second support member extending outwardly therefrom intermediate the first and second ends of the body, the second support member including a pair of legs and a catch pin extending through the legs of the second support member. In an embodiment, the handle includes a trigger that engages releasably the catch pin when the handle is in its closed position. In an embodiment, the trigger includes a trigger spring. In an embodiment, the handle is moveable to a free position that is intermediate the closed position of the handle and the open position of the handle when the trigger disengages the catch pin. In an embodiment, when the handle is moved from its open position to its closed position, the first links rotate in the second direction and the second links rotate in the first direction until each of the corresponding first and second links are aligned with one another, each of the guide pins moves within the corresponding slot of the second links from the second end of the slot of the second link to the first end of the slot of the second link, each of the bushings move within the corresponding slots of the side portions of the body from the corresponding first end of the slot to the corresponding second end of the slot, and the trigger engages the catch pin.

In an embodiment, the latch can be mounted deep down in a narrow compartment (such as an engine compartment), while a handle of the latch extends to the skin of the engine compartment that allows one to operate the latch freely without reaching into the compartment. In an embodiment, the latch provides the handle's pivot point closer to the engine skin, where it does not require a wider rear engine compartment for penetration of the handle. The middle link is utilized to connect the two jointed/pivoted front and back links at its one end with the front link's slot, and its other end pivots with the handle. The middle link acts as an extended arm to drive both the front and back links for opening and closing the latch.

In an embodiment, the latch is adapted for use in the aerospace field, such as aerospace doors, nacelles, etc. In other embodiments, the latch can be used in other fields and applications.

### BRIEF DESCRIPTION OF THE DRAWINGS

FIG. 1 is a top perspective view of a latch in accordance with an embodiment, the latch being shown in a closed position;

FIG. 2 is a bottom perspective view of the latch shown in FIG. 1;

FIG. 3 is a side elevational view of the latch shown in FIG. 2;

FIG. 4 is a side elevational view of the latch shown in FIG. 3, but with the latch shown in a free position that is intermediate an open position and the closed position during an opening sequence, the handle being shown transparently to show inner components thereof;

FIG. 5 is a side elevational view of the latch shown in FIG. 4, but with the latch shown in the open position;

FIG. 6 is a side elevational view of the latch shown in FIG. 5, but with the latch shown between and open position and a closed position during a closing sequence; and

FIG. 7 is a side elevational view of the latch shown in FIG. 6, but with the look latch shown in its closed position.

### DETAILED DESCRIPTION OF THE DRAWINGS

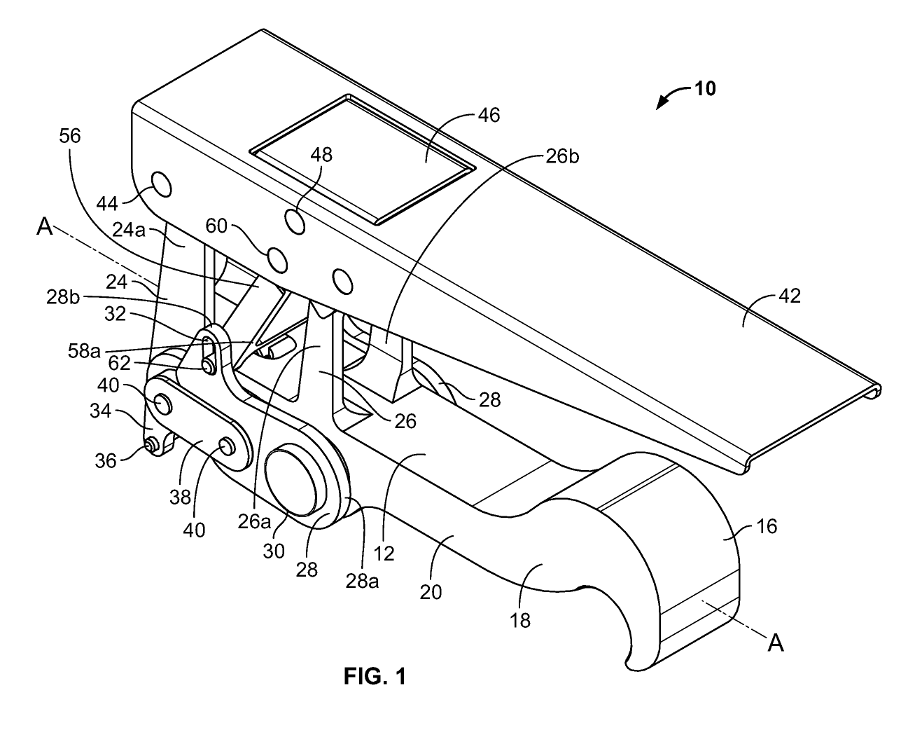

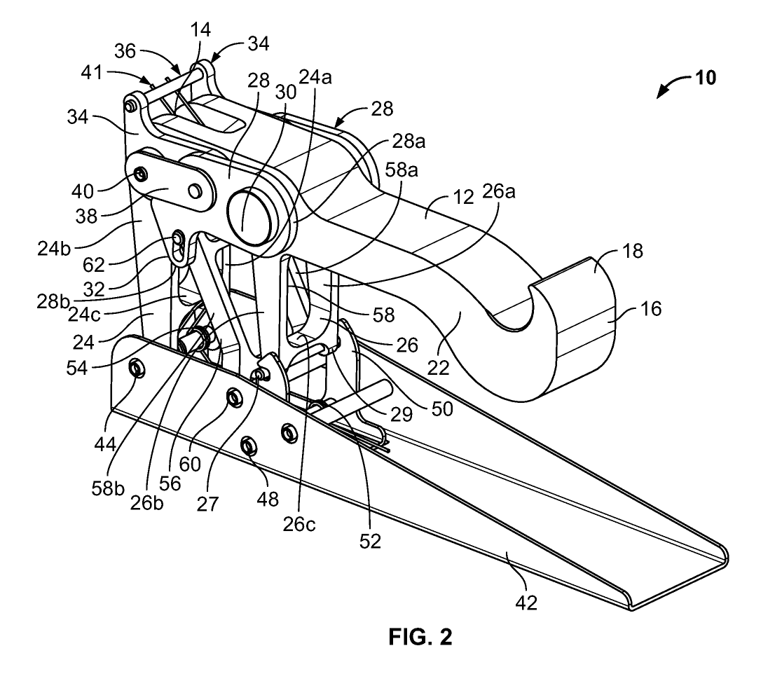

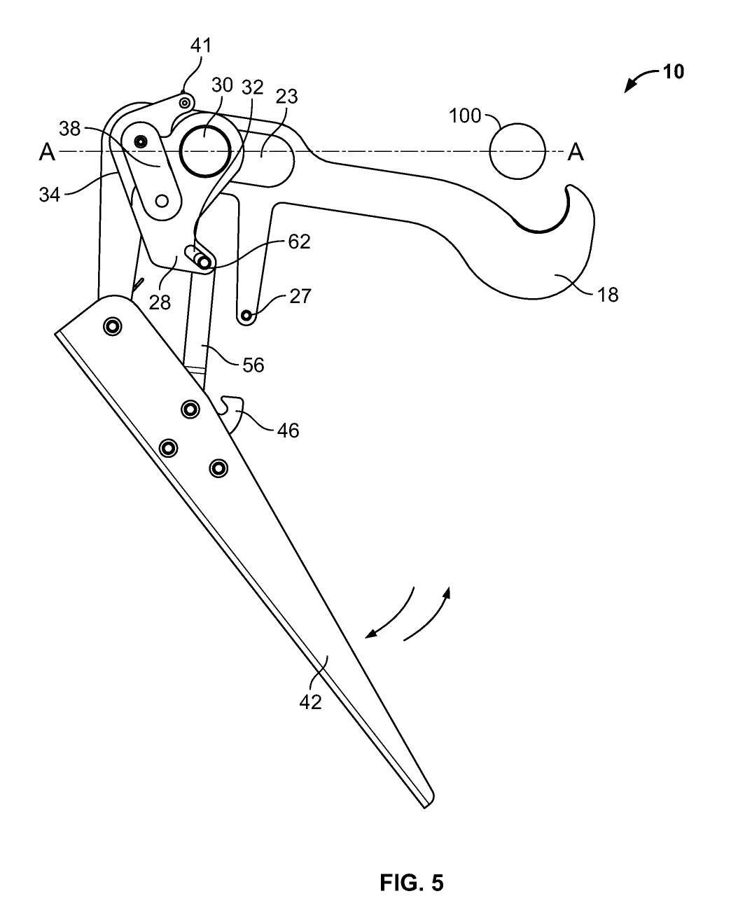

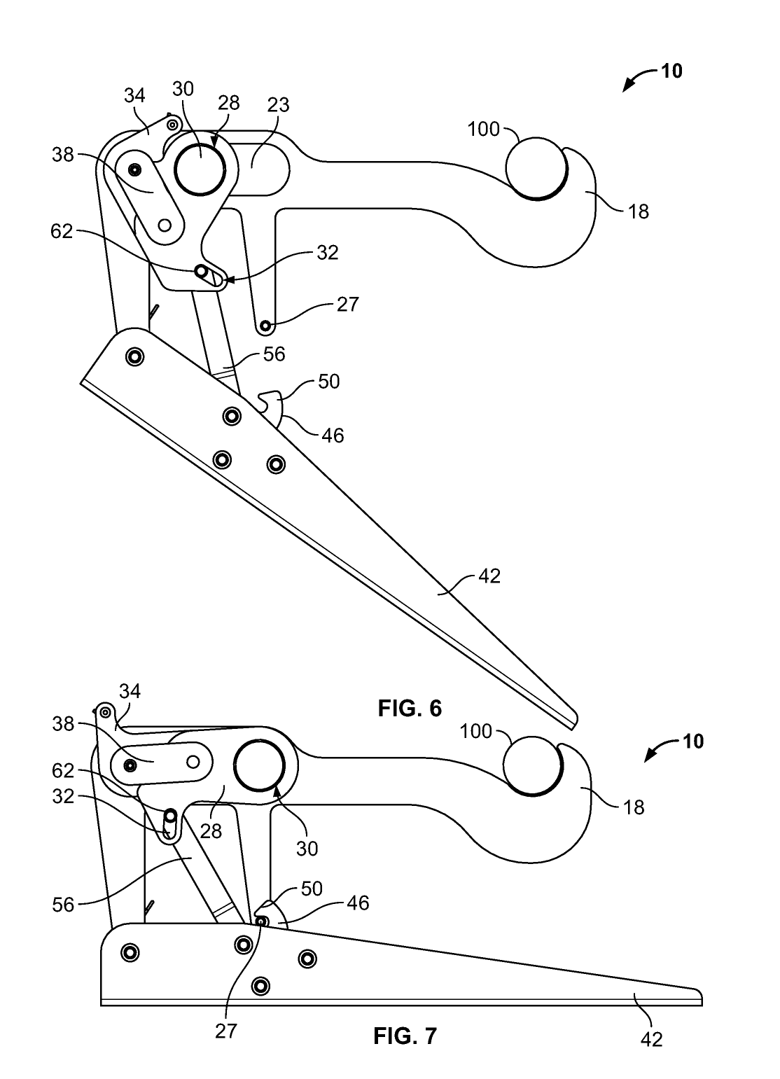

Referring to FIGS. 1 and 2, in an embodiment, a latch 10 having a body 12 with a first end 14, a second end 16 opposite the first end 14, a hook 18 located at the second end 16, and side portions 20, 22 located between the first and second ends 14, 16. In an embodiment, the hook 18 need not be included and replaced with other latch components known in the art. In an embodiment, each of the side portions 20, 22 include an elongated slot 23 formed therein and extending axially along a longitudinal axis A of the body 12 (not shown in FIG. 1 or 2, but see FIGS. 5 and 6). In an embodiment, a first support member 24 extends outwardly from the body 12 proximate to the first end 14 thereof, while a second support member 26 extends outwardly from the body 12 intermediate the first and second ends 14, 16 thereof. In an embodiment, the first support member 24 includes a pair of legs 24a, 24b spaced apart from another and connected by a crossbar 24c, while the second support member 26 includes a pair of legs 26a, 26b spaced apart from one another and connected by a crossbar 26c. In an embodiment, a free end 29 of the second support member 26 includes a catch pin 27 extending through the legs 26a, 26b thereof. In an embodiment, each of a pair of front links 28 is attached to a corresponding one of the side portions 20, 22 of the body 12 by a mounting bushing 30 at an end 28a thereof and proximate to the first end 14 of the body 12. In an embodiment, each of the front links 28 is J-shaped. In an embodiment, the mounting bushings 30 are each positioned within a corresponding one of the slots 23. In an embodiment, the bushings 30 are sized and shaped to slide with the corresponding slots 23. In an embodiment, an opposite end 28b of each of the front links 28 includes an elongated slot 32. In an embodiment, each of a pair of back links 34 is attached to a corresponding one of the side portions 20, 22 of the body 12 proximate to the first end 14 of the body 12. In an embodiment, each of the front links 28 overlaps a corresponding one of the back links 34. In an embodiment, an elongated back link rivet 36 extends between and interconnects the back links 34. In an embodiment, each of a pair of link covers 38 connects a corresponding one of the front links 28 with a corresponding one of the back links 34 and is attached thereto by hook rivets 40. A hook spring 41 surrounds the hook rivets 40 and ends of the hook spring 41 engage the back link rivet 36.

Still referring to FIGS. 1 and 2, in an embodiment, the latch 10 includes a handle 42 attached rotatably to the first end 14 of the body 12 by a handle rivet 44 and is moveable from a closed position to an open position, and vice-versa. In an embodiment, the handle 42 includes a trigger 46 mounted to the handle 42 by a trigger rivet 48. In an embodiment, the trigger 46 includes detents 50 that engage the catch pin 27 when the handle 42 is in its closed position. In an embodiment, the trigger 46 includes a trigger spring 52. In an embodiment, when the trigger 46 is depressed, the detents 50 disengage the catch pin 27 to enable the handle 42 to move from the closed position to the open position, and, thus, retract the hook 18, which will be described below. In an embodiment, a handle spring 54 surrounds the handle rivet 44 in order to maintain the handle 42 in its free position, as shown in FIG. 4.

Still referring to FIGS. 1 and 2, in an embodiment, the latch 10 includes a middle link 56 having a pair of elongated link members 58a, 58b. First ends of the link members 58a, 58b are attached to the handle 42 by a link rivet 60, while second ends of the link members 58a, 58b are each attached to a corresponding one of the front links 28 by a corresponding guide pin 62, which resides movably within the corresponding slot 32 of the corresponding front link 28 between a first end of the slot 32 to a second end of the slot 32 opposite the first end of the slot 32.

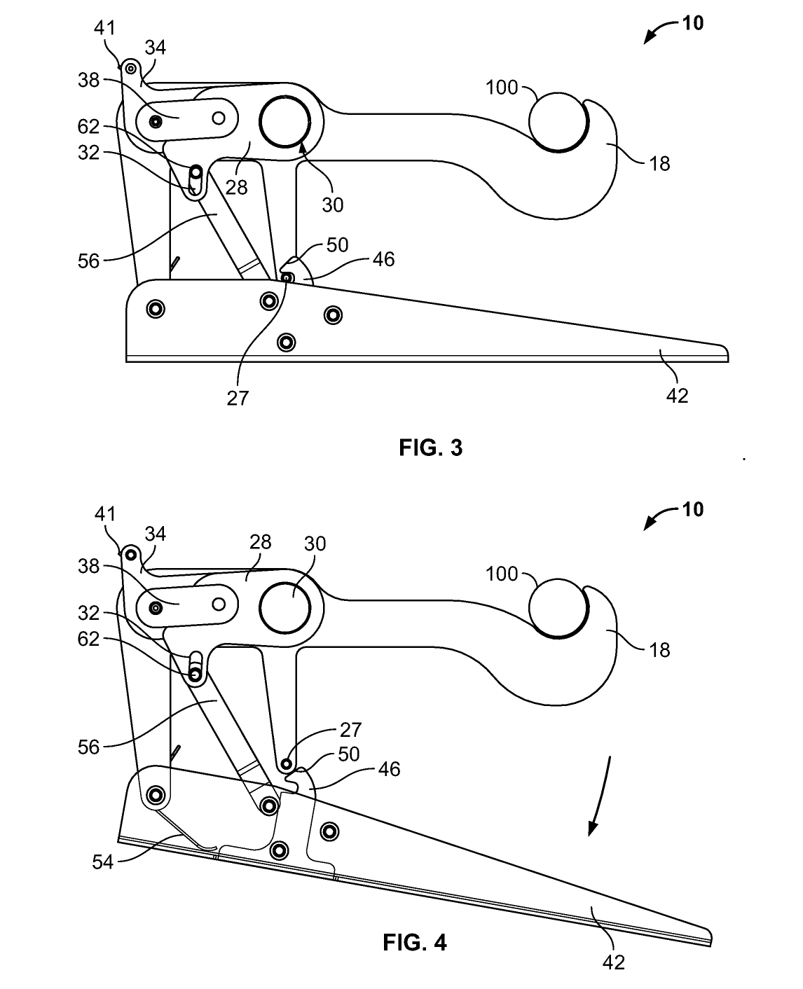

Referring to FIGS. 3 through 5, the opening sequence of the latch 10 is provided as follows. In an embodiment, the latch 10 is shown engaged to a mating pin 100, which is a component of a door, panel, or the like. From the closed position of the latch 10 wherein the hook 18 is engaged with the mating pin 100, as shown in FIG. 3, the trigger 46 is pressed and the detents 50 disengage the catch pin 27 to allow the handle 42 to drop (i.e., pop out) to a free position that is intermediate the closed position and the open position of the latch 10, as shown in FIG. 4. In this regard, when the handle 42 is popped-out into the free position, the handle 42 pulls the middle link 56 to drive the guide pins 62 from the first end of the slots 32 of the front links 28 to the second ends of the slots 32 (see FIG. 4). As shown in FIGS. 4 and 5, the handle 42 then rotates clockwise to untoggle each of the back links 34 from the corresponding one of the front links 28. The hook spring 41, which surrounds the hook rivet 40, gives a jolt to the back links 34 to fold the front links 28 in a scissor-like movement and in a counterclockwise direction, while the back links 34 move in a clockwise direction, and forces the hook 18 to move forward and clockwise until it stops, and the latch 10 is in its open position, as shown in FIG. 5. During this movement, the bushings 30 move within the corresponding slots 23 of the side portions 20, 22 from second ends of the slots 23 to the first ends of the slots 23. The hook member 18 disengages and clears the mating pin 100.

Referring to FIGS. 5 through 7, the closing sequence of the latch 10 is provided as follows. From the open position of the latch 10 (shown in FIG. 5), the handle 42 is rotated counterclockwise to engage the hook 18 with the mating pin 100. The handle 42 continues to rotate counterclockwise, which forces the guide pins 62 to move from the second ends of the slots 32 of the front links 28 to first ends of the slots 32. The rotation of the handle 42 pushes the front links 28 and causes them to rotate clockwise, which, in turn, moves the back links 34 counterclockwise in a scissor-like movement, until the corresponding front links 28 and back links 34 are toggled and aligned with one another. During this movement, the bushings 30 move within the corresponding slots 23 of the side portions 20, 22 from the first ends of the slots 23 to the second end of the slots 23. The detents 50 of the trigger 46 then engage the catch pin 27 to complete the closed position of the latch 10.

What is claimed is:

1. A latch, comprising:
a body having a first end, a second end opposite the first end, a hook located at the second end, and a pair of side portions located intermediate the first and second ends, the body being moveable axially and rotatably from a first position to second position;
a handle attached pivotally to the first end of the body, the handle being moveable from a closed position, in which a portion of the handle is attached releasably to the body, and an open position, in which the portion of the handle is detached from the body;
a pair of first links, each of which is attached rotatably to a corresponding one of the side portions of the body proximate to the first end of the body, each of the first links being moveable from a first position to a second position;
a pair of second links, each of which is attached rotatably to a corresponding one of the side portions of the body proximate to the first end of the body and overlapping a corresponding one of the first links, each of the second links being moveable from a first position to a second position; and
a third link having a pair of elongated link members, a first end of each of the link members being attached to a corresponding one of the second links and an opposite, second end of each of the link members being attached to the handle,
when the handle is pivoted from its closed position to its open position, the handle pulls the third link which, in turn, rotates each of the second links from its first position to its second position and each of the first links from its first position to its second position,
and when each of the second links is moved to its second position, the body moves from its first position to its second position.

2. The latch of claim 1, wherein each of the side portions of the body includes an elongated slot, and each of the second links includes a first end and a second end opposite the first end of the second link, each of the first ends of the second links being attached to the corresponding one of the side portions of the body by a mounting bushing positioned moveably within a corresponding one of the slots of the side portions of the body.

3. The latch of claim 2, wherein each of the second ends of the second links includes an elongated slot having a first end and a second end opposite the first end of the slot of the second link, each of the second ends of the link members of the third link being attached to a corresponding one of the first ends of the second links by a guide pin positioned moveably within a corresponding one of the slots of the second links.

4. The latch of claim 3, wherein when the handle is moved from its closed position to its open position, the first links rotate in a first direction and the second links rotate in a second direction opposite the first direction, each of the guide pins moves within the corresponding slot of the second links from the first end of the slot of the second link to the second end of the slot of the second link, and each of the bushings move within the corresponding slot of the side portions of the body from the corresponding second end of the slot to the corresponding first end of the slot.

5. The latch of claim 3, further comprising a back link rivet extending between and interconnecting the pair of first links to one another.

6. The latch of claim 5, further comprising a pair of link covers, each of which connects a corresponding one of the second links with a corresponding one of the first links by a pair of hook rivets.

7. The latch of claim 6, further comprising a spring positioned on one of the hook rivets and engaging the back link rivet.

8. The latch of claim 7, wherein the handle includes a pair of side members, and the body includes a first support member extending outwardly from the first end thereof, the first support member including a pair of legs, each of which is attached to a corresponding one of the side members of the handle by a handle rivet.

9. The latch of claim 8, further comprising a handle spring located on the handle rivet.

10. The latch of claim 9, wherein the body includes a second support member extending outwardly therefrom intermediate the first and second ends of the body, the second support member including a pair of legs and a catch pin extending through the legs of the second support member.

11. The latch of claim 10, wherein the handle includes a trigger that engages releasably the catch pin when the handle is in its closed position.

12. The latch of claim 11, wherein the trigger includes a trigger spring.

13. The latch of claim 12, wherein the handle is moveable to a free position that is intermediate the closed position of the handle and the open position of the handle when the trigger disengages the catch pin.

14. The latch of claim 4, wherein when the handle is moved from its open position to its closed position, the first links rotate in the second direction and the second links rotate in the first direction until each of the corresponding first and second links are aligned with one another, each of the guide pins moves within the corresponding slot of the second links from the second end of the slot of the second link to the first end of the slot of the second link, each of the bushings move within the corresponding slots of the side portions of the body from the corresponding first end of the slot to the corresponding second end of the slot, and the trigger engages the catch pin.
